(19) United States
(12) Patent Application Publication
(10) Pub. No.: US 2004/0121891 A1
(43) Pub. Date: Jun. 24, 2004

(54) Stage cut patterns for linear drawn composite containers

(75) Inventor: Manson Drew Case, Hartsville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc., Hartsville, SC (US)

(21) Appl. No.: 10/324,236

(22) Filed: Dec. 19, 2002

(51) Int. Cl. B31B 7/14

(52) U.S. Cl. 493/56

(57) ABSTRACT

A machine and process for forming a container are disclosed. In one method, at least one layer forming the container is directed to a first cutting device, which forms a cut at least partially through the at least one layer. A downstream second cutting device forms a cut at least partially through the at least one layer, such that the cuts cooperate to form a cut substantially the width of the at least one layer. By only cutting a portion of the at least one layer with the first cutting device, the machine can pull or direct the at least one layer therethrough, while the second cutting device cuts the remaining portions of the at least one layer so that the individual containers can be easily formed.

### BACKGROUND OF THE INVENTION

Composite containers can be formed by a variety of methods. One such method is known as a linear draw method, whereby the layers forming the composite container are directed along a generally straight path and wrapped around a mandrel with the assistance of forming shoes and the like. In particular, puller belts and wheels pull the layers, which are typically laminated together upstream of the mandrel, through the forming shoes and about the mandrel. While round or tubular shapes can be formed using the linear draw method, this method is particularly advantageous for producing non-round containers. Non-round containers are typically used for non-liquid products, such as coffee, iced tea granules, powdered materials, nuts, potato chips, and the like.

Another advantage to manufacturing containers using the linear draw method is that the label ply is easier to apply and produce than other container-forming methods. In particular, conventional spiral winding methods, in which the layers of the container are helically wrapped about a tubular mandrel, often require the graphics on the label ply of the container to be initially distorted and scaled, as the spiral winding process then stretches and removes the initial distortion. The distortion addition and removal process is difficult to produce, however, and often results in waste and off-quality container production. By contrast, the linear draw method does not require or create any distortion of the label ply, so the label can be produced distortion-free at full scale.

After the layers have been formed into the desired shape, the individual containers are formed by cutting through the shaped layers. Typically this is performed by a complex arrangement of cutting blades, which often operate in a fashion similar to the iris of a camera, whereby multiple angled blades converge towards a central point. This cutting arrangement is quite slow and not very reliable due to the multitude of parts and complex operation.

Another method for forming linear draw containers includes placing a rotary cutter in the path of travel of the laminated layers that cuts through the layers before the layers have been shaped by the mandrel and forming shoes. While this method eliminates the complex arrangement of cutting blades as described above, the individually cut containers are difficult to direct into the forming shoe and around the mandrel. As a result, this method produces an inordinate amount of waste and number of machine jams, which slow the processing speed and reduce throughput. Accordingly, there is a need to reduce waste and complexity in the linear drawn method of forming composite containers, yet maintain speed and throughput.

### BRIEF SUMMARY OF THE INVENTION

These and other needs are provided by the apparatus and method of the present invention, which provide a stage cutting method for linear drawn composite container production. In particular, a series of sequential cutting steps are provided that occur at alternative positions along the linear path of travel, whereby part of the layers forming the composite container are cut by a first cutting device, and a substantial remainder, if not all, of the layers are cut with a second cutting device, which is downstream of the first cutting device. Advantageously, the first and second cutting devices are positioned such that the layers forming the composite container, which typically includes at least one body ply, a liner ply, and a label ply, are easily directed through the forming shoes and over the mandrel without sacrificing line speed or producing substantial downtime or waste.

In particular, one method according to the present invention includes directing at least one layer forming the container, such as a label ply, a body ply, and a liner ply, along a path of travel and forming a first cut at least partially through the plies such that the width of the first cut is less than the width of the plies. A second cut is then produced downstream, whereby the first cut and second cut cooperate to extend substantially across the width of the plies. The first and second cuts may be equal in length to one another or may have different lengths. In one embodiment, the first cut extends entirely through the plies forming the container, and the second cut extends only partially through the plies, such as through all the plies except for the liner ply. The opposite may also be true. In addition, either or both of the cuts may only perforate one or more of the plies instead of cutting.

The method also includes shaping the plies into a predetermined shape, such as a polygon. The plies are directed over a forming shoe and about a mandrel, and in one embodiment first cut and the second cut are performed before the shaping step, while in another embodiment the first cut is performed before the shaping step while the second cut is performed after the shaping step.

The location of the first cut and the second cut may vary along the width of the plies. In one embodiment, the first cut includes two cuts in the opposite edges of the plies, and the second cut includes a cut extending across the medial portion of the plies such that the first and second cuts are aligned across the width of the plies. Other combinations of cuts and cut sequences are possible, such as cutting a medial portion of the plies first and then cutting the opposite edges of the plies such that the cuts align or cooperate across the width of the plies. At the end of the linear draw process any remaining uncut plies of the shaped composite containers can be either cut or pulled apart.

Advantageously, the linear draw machine and associated methods according to the present invention allow the plies to be cut in sections or stages in a predetermined pattern so that the plies can be pulled or directed through the machine efficiently by leaving at least one of the layers intact as the plies are directed therethrough. Accordingly, the linear draw machine and associated liner draw methods result in producing more containers while producing less waste and causing less machine jams.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a linear draw machine for manufacturing composite containers according to one embodiment of the present invention;

FIG. 2 is a plan view of a composite structure having a plurality of cuts along the width thereof according to one embodiment of the present invention;

FIG. 3 is a plan view of a composite structure having a plurality of cuts along the width thereof according to another embodiment of the present invention;

FIG. 4 is a cross-sectional view of a first cutting device and the composite structure shown along lines 4--4 of FIG. 1;

FIG. 5 is a cross-sectional view of the first cutting device and the composite structure shown along lines 5--5 of FIG. 1;

FIG. 6 is a cross-sectional view of a second cutting device and the composite structure shown along lines 6--6 of FIG. 1;

FIG. 7 is a cross-sectional view of a second cutting device and the composite structure shown along lines 7--7 of FIG. 1; and

FIG. 8 is a perspective view of a linear draw machine for manufacturing composite containers according to an alternative embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

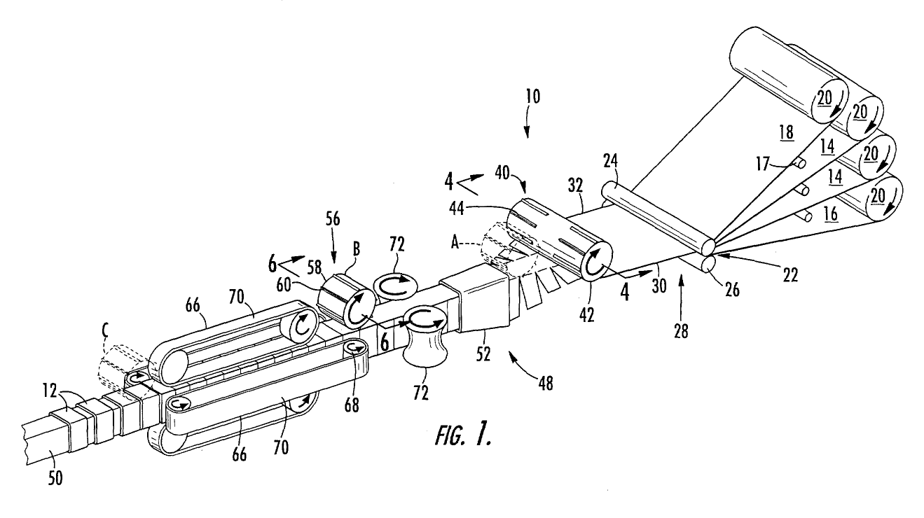

FIG. 1 shows a perspective view of a linear draw machine 10 according to one embodiment of the present invention. The machine 10 is used to form containers 12, such as composite container as shown that are formed of a plurality of plies or layers. In particular, the containers 12 are formed of at least one body ply 14, such as a paperboard body ply. A liner ply 16 and a label ply 18 may also be included along with adhesive layers (not shown) therebetween. In one embodiment, the adhesive layers are applied by glue applicator rolls 17, which preferably transfer a “cold” glue, such as EVA, PVA, or dextrine, on the layers that creates a strong bond therebetween without external heat being applied. Alternatively, a “hot melt” glue may be used, as discussed below. The containers 12 can be formed into a variety of shapes, including round and non-round shapes. However, the machine 10 is particularly advantageous for forming non-round shapes, such as rectangular or square containers. These shapes are often used for packaging a wide variety of products, such as coffee, iced tea granules, powdered beverages, nuts, chips, and other snacks. End caps (not shown) are applied to the ends of the containers 12 after the containers are formed by the machine 10, and vacuum packaging may also be used to protect and preserve the products.

According to one embodiment, the body plies 14, liner ply 16, and label ply 18 are payed out from rolls 20 and directed to a nip 22 formed by a press roll 24 and a transfer roll 26, which may be heated if a hot melt adhesive is used. The nip 22 acts to laminate the plies or layers together to form a composite structure 28 that becomes the major portion of the container 12. The composite structure 28 has a predetermined width W, which is typically between about 6″ and about 30″, and defines opposite edges 30, 32 and a medial portion 34.

After the nip 22, the composite structure 28 travels along a generally linear path and encounters a first cutting device 40. According to one embodiment, the first cutting device 40 is a rotary cutter formed of a tubular body 42 having a plurality of cutting blades 44 extending from the outer surface of the body 42. In the embodiment shown in FIG. 1, the first cutting device 40 includes cutting blades 42 that are positioned in pairs across the tubular body 42 such that a gap is left between the cutting blades. In this manner, the cutting blades are positioned to cut the opposite edges 30, 32 of the composite structure 28, yet leave the medial portion 34 of the composite structure uncut. Accordingly, the composite structure 28 is directed into engagement with the cutting blades 42 of the first cutting device 40, and the blades cut at least partially through the composite structure as described above.

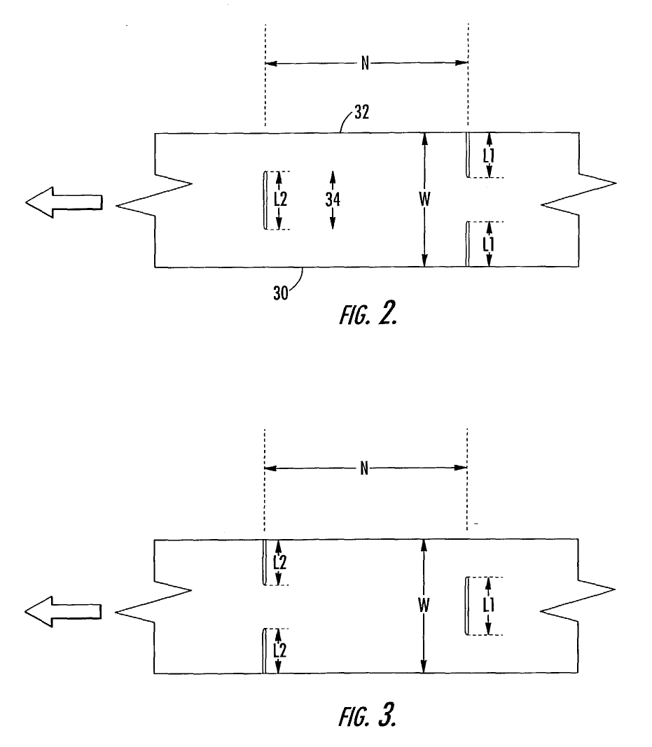

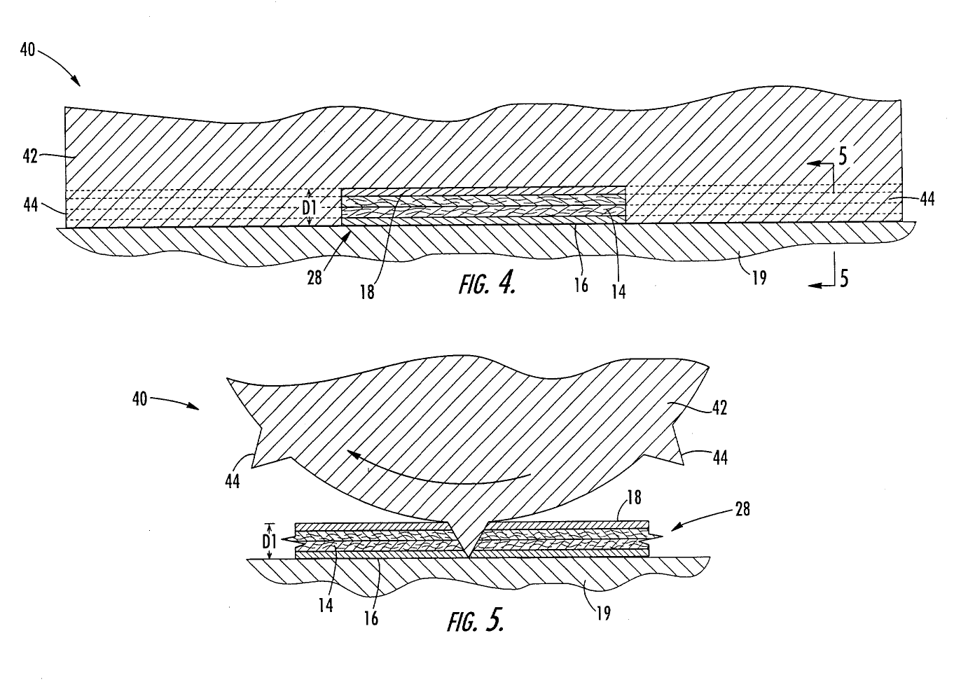

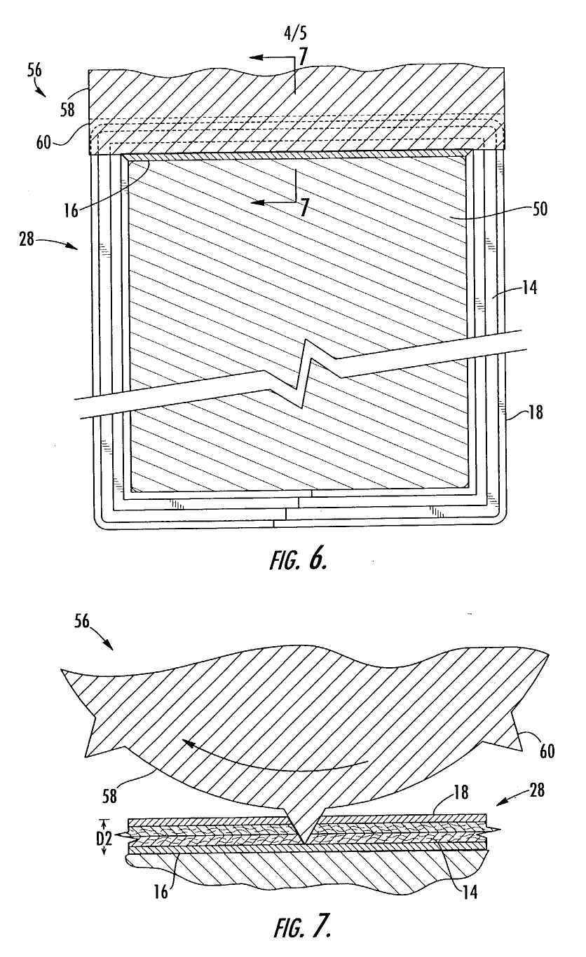

As shown in FIG. 2, each of the cutting blades 42 of the first cutting device 40 has a predetermined length L1, which collectively are less than the width W of the composite structure 28. As shown in FIGS. 4 and 5, which show cross-sectional views of the first cutting device 40 and the composite structure 28, the first cutting device can be positioned to cut a predetermined depth D1 into the composite structure depending on the desired outcome. For example, the first cutting device 40 may be positioned such that the cutting blades 42 cut through the label ply 18 and body plies 14, but not through the liner ply 16. A cutting surface 19 is provided below the composite structure 28 so that the first cutting device 40 can make accurate cuts. In a preferred embodiment, each cutting blade 42 cuts completely through the composite structure 28 for the length L1. Alternatively, the cutting blades 42 may act to perforate one or more of the plies forming the composite structure 28, which may provide the composite structure with more rigidity yet still allow the shaped containers 12 to be pulled apart downstream, as discussed below.

After being cut or perforated by the first cutting device 40, the composite structure 28 travels along the generally linear path to a shaping device 48, which shapes the composite structure into a predetermined shape, such as rectangular, square, or other non-round shape, although round shapes are possible. The shaping device 48 includes a mandrel 50 and at least one forming shoe 52 that cooperate to shape the composite structure 28. In particular, the composite structure 28 is directed between the mandrel 50 and the forming shoe 52, whereby the composite structure is shaped accordingly. As shown in FIG. 1, the composite structure 28 is folded or shaped around the mandrel at the plurality of cuts formed by the cutting blades 42 of the first cutting device 40. The cutting blades 44 and cuts are separated by a distance N, which generally dictates the thickness or length of the resulting containers 12. While the cuts extending completely through the composite structure 28 are helpful when directing the composite structure between the mandrel 50 and forming shoe 52, the composite structure can be directed as such even without a single cut.

As shown in FIG. 1, the composite structure 28 is shaped into a desired configuration by the mandrel 50 and forming shoe 52, and is directed further downstream. The composite structure 28 is directed along the generally linear path of travel by a pulling device 66, which preferably includes driven rollers 68 and an endless belt 70. Other types of pulling devices known in the art could be used in addition to or alternatively to the pulling device 66 shown in FIG. 1. Preferably, pulling devices 66 are located on each side of the shaped containers 12, although less pulling devices can be used. Guide rolls 72 may also be used to help direct the composite structure 28 along the path of travel. The guide rolls 72 may also be used to help wrap the opposite edges 30, 32 of the composite structure 28 around the mandrel. In this case, the guide rolls 72 have an hourglass (as shown in FIG. 1) or suitable shape for directing the edges of the composite structure about the mandrel.

In a preferred embodiment, the composite structure 28 is directed to a second cutting device 56 that is positioned to cut the remaining un-cut portion (i.e., the medial portion 34 according to the embodiment shown in FIG. 1) of the composite structure. The second cutting device 56 includes a tubular body 58 having a plurality of blades 60 extending therefrom in a manner similar to the first cutting device 40, except in the embodiment shown in FIG. 1 the cutting blades 60 of the second cutting device are positioned to engage the medial portion 34 of the composite structure 28. The cutting blades 60 have a length L2 and are spaced from one another by the same distance N as the blades 44 of the first cutting device 40. The first and second cutting devices 40, 56 are driven, such as by mechanical means, servo motor, or the like, such that the cuts formed by the second cutting device 56 are aligned with the cuts formed by the first cutting device 40 and the cuts cooperate to extend substantially or the entire width W of the composite structure 28. In other words, the formula [L1+L2=W] generally applies to show that the sum of the cuts formed by the first cutting device 40 and the cuts formed by the second cutting device 56 equal or substantially equal the width of the composite structure 28 regardless of the depth of each cut.

The cutting blades 60 can be positioned to cut a distance D2, which may be partially or completely through the composite structure 28. Whether to cut all the way through the composite structure 28 with the second cutting device 56 is influenced by the location of the second cutting device along the path of travel of the composite structure. In particular, the second cutting device 56 is shown in FIG. 1 as being at a position B, which is upstream of the pulling device 66, although alternative positions, such as position A or C (wherein the second cutting device is depicted in broken lines) are also possible. If the second cutting device 56 is positioned upstream of the pulling device 66, and particularly upstream of the forming shoe 52, then care must be taken such that either the cuts formed by the first cutting device 40 or the cuts formed by the second cutting device 56 do not extend completely through the composite structure 28, as cutting completely through the composite structure 28 at this stage would make directing the cut strips of the composite container difficult to direct between the mandrel 50 and forming shoe 52, which has been recognized above as a problem and disadvantage in conventional linear draw processes.

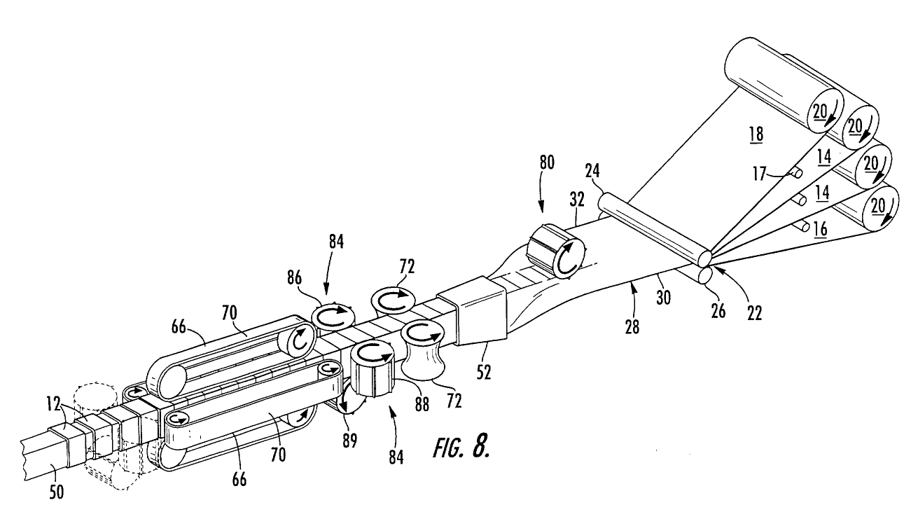

As shown in FIGS. 1, 6, and 7, the second cutting device 56 is positioned at position B whereby the cutting blades 60 form cuts to a depth D2 that do not extend completely through the composite structure 28. In particular, FIGS. 6 and 7 show cross-sectional views of the second cutting device 56 along the path of travel and transverse thereto, respectively. As illustrated in FIGS. 6 and 7, the label ply 18 and body plies 14 are cut, but the liner ply 16 is not cut by the second cutting device 56. Leaving the liner ply 16 intact provides enough strength and structural integrity to the composite structure 28 such that the pulling device 66 can pull the composite structure through the machine 10, including through the nip 22 and between the mandrel 50 and forming shoe 52, without breaking the liner ply and separating the composite structure too early. It should be noted that the label ply 18, body plies 14, and liner ply 16 are shown as having butt joints for convenience purposes only and are not limited as such. In particular, other conventional seams and joints, such as overlapping, anaconda, and the like, can be created as well.

A similar cut depth, such as depth D2, would be appropriate if the second cutting device 56 were positioned at alternative position A, as position A is upstream of the pulling device 66 and thus some portion of the composite structure 28 should remain intact in order for the pulling device to pull the composite structure through the machine 10, as discussed above.

If the second cutting device 56 is located in positions A or B, then the partially-cut composite structure 28 is directed downstream and adjacent the pulling device 66. The composite structure 28 is pulled apart by the pulling device(s) so as to form the separate containers 12. This can be achieved by moving part of the pulling device 66, preferably at the downstream end of the pulling device, faster than the remainder of the pulling device. As such, tension is created on the partially-cut composite structure 28 until the remaining un-cut portion of the composite structure is broken and the separate containers 12 are formed.

Alternatively, the second cutting device 56 can be positioned at position C, which is downstream of the pulling device 66. In position C, the second cutting device is preferably capable of cutting completely through the shaped composite structure 28 to form the separate containers 12. Advantageously, the second cutting device 56 only is required to cut through the remaining un-cut portion of the composite structure 28, which in FIG. 1 is the medial portion 34. Therefore, no complex arrangement of converging cutting blades is required to cut the individual containers 12, and thus the process according to the present invention is faster and more efficient than convention processes.

FIG. 8 represents an alternative embodiment, wherein the medial portion 34 of the composite structure 28 is cut first by a first alternative cutting device 80, which greatly resembles the second cutting device 56 shown in FIG. 1. In the embodiment shown in FIG. 8, the first alternative cutting device 80 is operable to cut at least partially through the composite structure 28 at the medial portion 34 thereof, and thereby leaving the opposite edges 30 of the composite structure uncut. A second alternative cutting device 84 is positioned downstream of the first alternative cutting device 80. Further cutting devices could also be added, although only two cutting devices are shown for clarity. In one embodiment, the second alternative cutting device 84 includes two or three rotating cutting bodies 86, 88, 89 that are positioned to cut at least partially through the remaining un-cut portions of the composite structure 28. The second alternative cutting device 84 can have other configurations depending on the desired shape of the containers 12 and the configuration of the first alternative cutting device 80. The exact location of the cuts and the positioning of the first and second alternative cutting devices 80, 84 can vary, but the same issues discussed above regarding the embodiment shown in FIG. 1 apply in the embodiment shown in FIG. 8. Namely, if the first and second alternative cutting devices 80, 84 are both upstream of the pulling device 66, at least part of the composite structure 28 should remain uncut so that the pulling device can pull the composite structure through the machine 10.

Accordingly, in the embodiment shown in FIG. 8, at least one of the first alternative cutting device 80 or second alternative cutting device 84, including at least one of the rotating cutting bodies 86, 88, 89 should engage the composite structure 28 so as to cut less than completely through the composite structure, and thus leaving a portion thereof uncut. In a preferred embodiment, the first alternative cutting device 80 does not cut completely through the composite structure 28, such as by cutting through all the layers of the composite structure except for the liner ply 16, while the second alternative cutting device 84 does cut completely through the composite structure. The pulling device 66 then pulls the partially-cut composite structure 28 through the machine 10 and breaks the uncut portion of the composite structure to form the individual containers 12. An operator can also break the uncut portions to form the individual containers manually, or other devices could be used for such a task, such as a mechanical separator.

Accordingly, the linear draw machine 10 and processes of the present invention provide a more efficient linear draw process for forming composite containers 12. In particular, the first and second cutting devices 40, 56 (or 80, 84) provide efficient stage cutting with less parts, more reliability, and greater line speed and throughput. Because at least part of the composite structure 28 forming the containers 12 remains uncut for a predetermined distance along the path of travel, the composite structure is easily directed through the machine while substantially eliminating excess waste, scrap, and jams in the machine.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of forming a composite container, comprising:
directing at least one layer forming the container along a linear path of travel, the at least one layer having a predetermined width;
forming a first cut at least partially through the at least one layer along the width thereof for a first predetermined distance that is less than the width of the at least one layer;
forming a second cut at least partially through the at least one layer along the width thereof for a second predetermined distance that is less than the width of the at least one layer, the first cut and the second cut cooperating to extend substantially across the width of the at least one layer; and
forming the at least one layer into a predetermined shape.

2. A method according to claim 1, wherein forming the first cut includes cutting entirely through the at least one layer for the first predetermined distance.

3. A method according to claim 1, wherein forming the first cut includes perforating the at least one layer for the first predetermined distance.

4. A method according to claim 1, wherein forming the second cut includes cutting through the at least one layer such that the first cut and the second cut are each less than completely through the at least one layer.

5. A method according to claim 1, wherein forming the second cut includes perforating the at least one layer for the second predetermined distance.

6. A method according to claim 1, wherein the first predetermined distance and the second predetermined distance are substantially equal.

7. A method according to claim 1, wherein forming the first cut includes forming a plurality of cuts.

8. A method according to claim 1, wherein forming the second cut includes forming a plurality of cuts.

9. A method according to claim 1, wherein forming the at least one layer includes forming the at least one layer into a polygon.

10. A method according to claim 1, wherein directing the at least one layer includes directing at least one paperboard body ply, a liner ply, and a label ply that have been laminated together.

11. A method according to claim 10, wherein forming the first cut includes cutting entirely through the at least one paperboard body ply, liner ply, and label ply for the first predetermined distance.

12. A method according to claim 10, wherein forming the first cut includes perforating the at least one paperboard body ply, liner ply, and label ply for the first predetermined distance.

13. A method of forming a composite container, comprising:
directing at least one layer forming the container along a linear path of travel, the at least one layer having a predetermined width;
shaping the at least one layer into a predetermined shape; and
forming a plurality of sequential cuts at least partially through the at least one layer across the width thereof, each cut being less than the width of the at least one layer.

14. A method according to claim 13, wherein forming the plurality of cuts includes forming at least three distinct cuts that cooperate to extend substantially the width of the at least one layer.

15. A method according to claim 13, wherein shaping the at least one layer includes defining an edge from which at least one of the plurality of cuts extends.

16. A method according to claim 13, wherein at least one of the plurality of cuts is formed before said shaping step.

17. A method according to claim 13, wherein forming the plurality of cuts includes cutting a pair of opposing edge cuts spaced across the width of the at least one layer to define a medial portion therebetween, and further cutting across the medial portion of the at least one layer such that the pair of opposing edge cuts and the medial portion cut cooperate to extend substantially the width of the at least one layer.

18. A method according to claim 17, wherein the pair of opposing edge cuts are formed before the shaping step.

19. A method according to claim 17, wherein the medial cut is formed after the shaping step.

20. A method according to claim 13, wherein the plurality of cuts are formed by rotating at least two sequential rotary cutters such that the plurality of cuts extend completely through the at least one layer.

21. A method according to claim 13, wherein the directing step includes directing at least one paperboard body ply and a liner ply along the path of travel.

22. A method according to claim 21, wherein forming the plurality of cuts includes cutting through the at least one paperboard body ply, but not through the liner ply.

23. A method of forming a composite container, comprising:
directing at least one layer forming the container along a linear path of travel, the at least one layer having a predetermined width and opposite edges;
forming a first cut in at least one of the opposite edges of the at least one layer and extending at least partially across the width thereof;
shaping the at least one layer into a predetermined shape; and
forming a second cut in the at least one layer, such that the first cut and the second cut cooperate to collectively extend across the width of the at least one layer.

24. A method according to claim 23, wherein forming the first cut includes forming a cut in each of the opposite edges of the at least one layer.

25. A method according to claim 23, wherein forming the second cut includes forming a cut along a medial portion of the at least one layer that extends at least to the first cut.

26. A method according to claim 23, wherein forming the second cut occurs before the shaping step.

27. A method according to claim 23, wherein forming the second cut occurs after the shaping step.

28. A method according to claim 23, wherein the first cut forming step includes extending the first cut completely through the at least one layer, and the second cut forming step includes extending the second cut less than completely through the at least one layer.

29. A method according to claim 28, wherein the first cut forming step and second cut forming step occur before the shaping step.

30. A method of forming a composite container, comprising:
directing at least one layer forming the container along a linear path of travel, the at least one layer having a predetermined width;
forming a first cut along a medial portion of the at least one layer that is less than the predetermined width thereof;
shaping the at least one layer into a predetermined shape; and
forming a pair of second cuts after the first cut forming step that cooperate with the first cut such that the first cut and second cuts collectively extend across the predetermined width of the at least one layer.

31. A method according to claim 30, further comprising pulling the at least one layer along the path of travel with a pulling device.

32. A method according claim 31, wherein the second cuts are formed after the pulling device.

33. A method according to claim 31, wherein the second cuts are formed before the pulling device, the second cuts extending less than completely through the at least one layer.

34. A linear draw machine for forming a composite container, comprising:
a first cutting device for receiving along a path of travel at least one layer that forms the composite container, the first cutting device operable to form at least one cut partially across the at least one layer;
a shaping device positioned along the path of travel of the at least one layer, the shaping device operable to shape the at least one layer into a predetermined shape; and
a second cutting device positioned downstream of the first cutting device along the path of travel, the second cutting device operable to form at least one cut partially across the at least one layer, such that the at least one cut formed by the first cutting device and the at least one cut formed by the second cutting device collectively extend substantially across the at least one layer.

35. A linear draw machine according to claim 34, wherein the first cutting device is a rotary cutter having at least one cutting surface extending therefrom.

36. A linear draw machine according to claim 34, wherein the first cutting device is positioned to cut less than completely through the at least one layer.

37. A linear draw machine according to claim 34, wherein the shaping device is capable of forming the at least one layer into a non-round configuration.

38. A linear draw machine according to claim 34, wherein the second cutting device is a rotary cutter having at least one cutting surface extending therefrom.

39. A linear draw machine according to claim 34, wherein the second cutting device is positioned to cut less than completely through the at least one layer.

40. A linear draw machine according to claim 34, further comprising a pulling device for pulling the at least one layer along the path of travel.

41. A linear draw machine according to claim 40, wherein the pulling device is positioned downstream of the second cutting device along the path of travel.
